(19) United States
(12) Patent Application Publication
(10) Pub. No.: US 2024/0372290 A1
(43) Pub. Date: Nov. 7, 2024

(54) New Enegy Charging Plug

(71) Applicant: Shenzhen Kule Youpin Technology Co., LTD., Shenzhen (CN)

(72) Inventor: Zhichao Wang, Shenzhen (CN)

(21) Appl. No.: 18/310,339

(22) Filed: May 1, 2023

(51) Int. Cl. H01R 13/447; H01R 27/02

(52) U.S. Cl. CPC H01R 13/447; H01R 27/02; B60L 53/16; H01R 2201/26

(57) ABSTRACT

The present application relates to a new energy charging plug, including a plug body and a protective cover configured for avoiding accidental electric shock; the center of the plug body is provided with a J1772 US-standard charging connector, the lower side of the J1772 US-standard charging connector is provided with a lock slot, the upper side of the charging connector is provided with a CCS1 US-standard charging connector; the protective cover is rotatably connected with the plug body, corresponding to a position of the CCS1 US-standard charging connector and closed with the CCS1 US-standard charging connector under normal conditions. The protective cover is used to close the CCS1 US-standard charging connector under normal conditions, so as to avoid unintended contact of the current in the CCS1 US-standard charging connector caused by misoperation during charging, and avoid safety accidents and improve safety.

### FIELD

The present application belongs to the technical field of new energy vehicle, particularly to a new energy charging plug.

### BACKGROUND

With the process that the new energy vehicle such as the electric vehicle is gradually emerged on the public entering into ordinary families, the new energy vehicle owns a huge development view and has broad market prospects. Currently, the energy supply of the new energy vehicle is mainly relied on charging piles in parking lots of urban communities or of charging stations. However, there is no charging piles in remote regions, the energy supply can only be relied on the power supply in house, but the socket of the charging pile and the household socket are different, and have different standards along with different protocols. As a result, a plurality of factories try to merge different sockets with different protocols to improve the compatibility of different protocols, but, because the charging current is a large current, if it doesn't get much attention when docking, it is very easy to mistakenly make sockets with different protocols touching the interface of the vehicle or use different protocols to charge different charging plugs, resulting in a surge in current or short circuit, then causing damagement.

### SUMMARY

In order to overcome the shortage mentioned in the background, there is a need to provide a new energy charging plug.

To achieve the above object, the present application provides the following technical solution: a new energy charging plug includes:

a plug body and a protective cover configured for avoiding accidental electric shock; the center of the plug body is provided with a J1772 US-standard charging connector, the lower side of the charging connector is provided with a lock slot, the upper side of the charging connector is provided with a CCS1 US-standard charging connector; the protective cover is rotatably connected with the plug body, corresponding to a position of the CCS1 US-standard charging connector and closed with the CCS1 US-standard charging connector under normal conditions.

Preferably, the protective cover is connected with the plug body by a spring pin shaft, the spring pin shaft passes through the protective cover.

In this way, the spring pin shaft provides a reset power for the protective cover, so that the protective cover is able to close the CCS1 US-standard charging connector under normal conditions, and be easily opened when the CCS1 US-standard charging connector is needed for use, which improves safety and practicality.

Preferably, the lock slot of the plug body is slidabley connected with a lock lever. In this way, the lock lever is configured to lock when the plug body and the vehicle are

fitted.

Compared with the prior art, the beneficial effects of the present application are as follows:

The protective cover is used to close the CCS1 US-standard charging connector under normal conditions, so as to avoid unintended contact of the current in the CCS1 US-standard charging connector caused by misoperation during charging, and avoid safety accidents and improve safety.

### BRIEF DESCRIPTION OF THE DRAWINGS

In order to more clearly illustrate the embodiment of the present application or the technical solution in the prior art, the following will be briefly introduced to the drawings required in the embodiment or prior art description, obviously, the following description of the drawings are only some embodiments of the present application, for those skilled in the art, without creative labor, other drawings can be obtained based on these drawings.

FIG. 1 is a schematic structural view of the new energy charging plug with a closed protective cover provided by an embodiment of the present application.

FIG. 2 is a schematic structural view of the new energy charging plug with an opened protective cover provided by an embodiment of the present application.

FIG. 3 is a breakdown structural view of the new energy charging plug provided by an embodiment of the present application.

The drawings are marked as follows:
1. the plug body; 2. the protective cover; 3. the lock slot; 4. the J1772 US-standard charging connector; 5. the lock lever; 6. the CCS1 US-standard charging connector; 7. the spring pin shaft.

### DETAILED DESCRIPTION

The present application will now be described in detail with reference to the accompanying drawings and embodiments in order to make the objects, technical solutions, and advantages of the present application more clear. It should be understood that the specific embodiments described herein are only for explaining the invention, and not intended to limit the present application.

In the present application, it is necessary to understand that the terms “center”, “longitudinal”, “horizontal”, “up”, “down”, “front”, “back”, “left”, “right”, “vertical”, “horizontal”, “top”, “bottom”, “inside”, “outside” and the other indicated direction or position relationship is based on the accompanying drawings, only for the convenience of describing the present application and simplifying the description, not to indicate or imply that the device or element referred to must have a particular orientation, constructed and operated in a particular orientation, so it cannot be understood as a limitation of the present application. In addition, the terms “first”, “second”, etc. are for descriptive purposes only and cannot be understood as indicating or implying relative importance or implicitly indicating the number of technical features indicated. Thus, the characteristics limited to “first”, “second”, etc. may explicitly or implicitly include one or more of the features. In the description of the present application, unless otherwise stated, the meaning of “plurality” is two or more than two.

In the present application, it is necessary to understand that unless expressly specified and qualified otherwise, the terms “installation”, “connection”, “connection” shall be understood in a broad sense, for example, it may be a fixed connection, a removable connection, or an integrated connection; It can be a mechanical connection or an electrical connection; It can be directly connected or indirectly through an intermediate medium, which can be a connection between two elements. For those of ordinary skill in the art, the specific meaning of the above terms in the present application may be understood by the specific circumstances.

The present application is further described below in conjunction with the accompanying drawings:

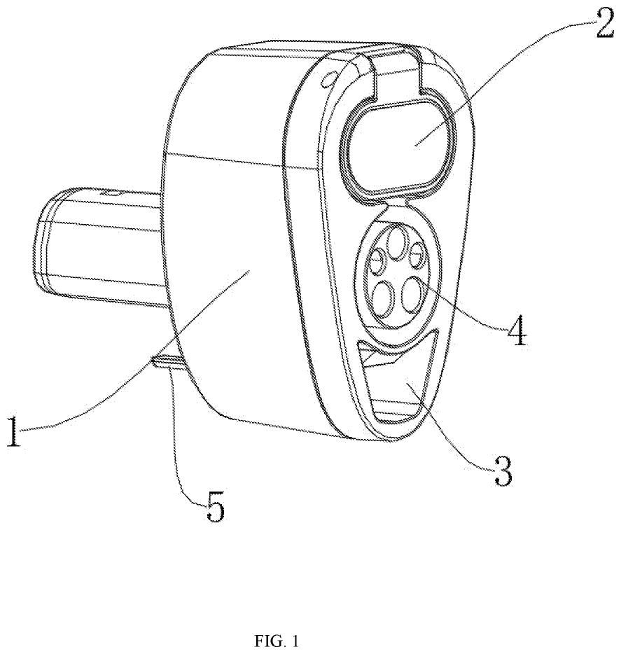

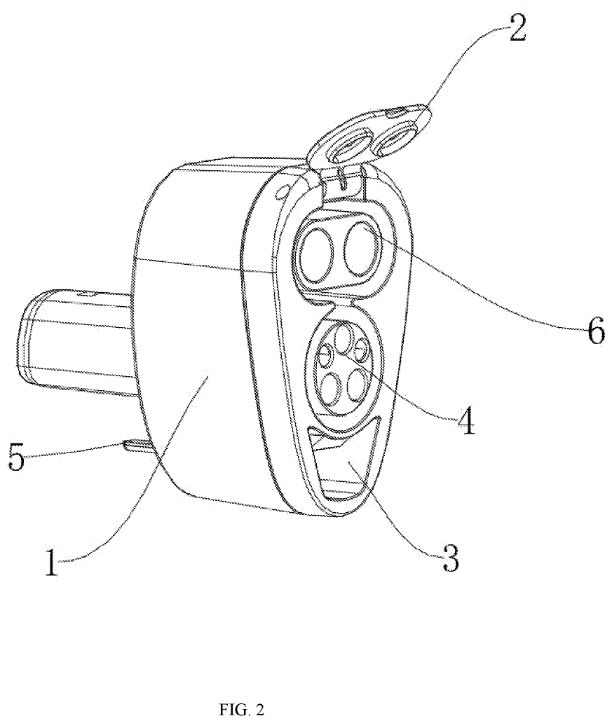

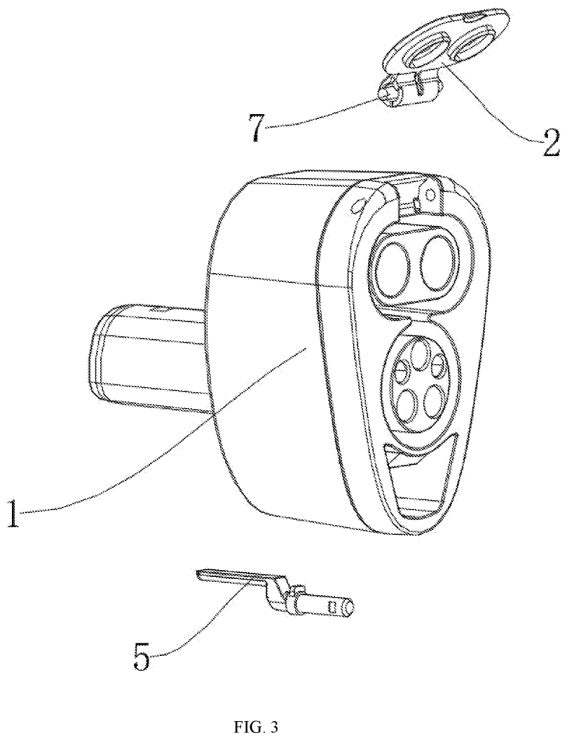

Referring to FIG. 1 to FIG. 3, an embodiment of the present application provides a new energy charging plug, including a plug body 1 and a protective cover 2 configured for avoiding accidental electric shock; the center of the plug body 1 is provided with a J1772 US-standard charging connector 4, the lower side of the J1772 US-standard charging connector 4 is provided with a lock slot 3, the upper side of the charging connector 4 is provided with a CCS1 US-standard charging connector 6; the protective cover 2 is rotatably connected with the plug body 1, corresponding to a position of the CCS1 US-standard charging connector 6, the protective cover 2 is closed with the CCS1 US-standard charging connector 6 under normal conditions.

In this embodiment, the protective cover 2 is connected with the plug body 1 by a spring pin shaft 7, the spring pin shaft 7 passes through the protective cover 2. The spring pin shaft 7 provides a reset power for the protective cover 2, so that the protective cover 2 is able to close the CCS1 US-standard charging connector 6 under normal conditions, and be easily opened when the CCS1 US-standard charging connector 6 is needed for use, which improves safety and practicality.

In this embodiment, the lock slot 3 of the plug body 1 is slidabley connected with a lock lever 5, the lock lever 5 is configured to lock when the plug body 1 and the vehicle are fitted.

The working principle: when the new energy charging plug is used, when the J1772 US-standard charging connector 4 is selected to supply power, because the spring pin shaft 7 provides a reset force on the protective cover 2, then the CCS1 US-standard charging connector 6 is covered by the protective cover 2. Even if the personnel operate the new energy charging plug violently or the new energy charging plug is skewed, the CCS1 US-standard charging connector 6 will not collide with external devices, so that no leakage accidents will occur. When the CCS1 US-standard charging connector 6 is selected, manually opening the protective cover 2, fliping the protective cover 2 and exposing the CCS1 US-standard charging connector 6, and then inserting the plug body 1 into the charging port of the vehicle to charge.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art, without departing from the concept of the present application, various modifications and improvements can be made and all fall within the protection scope of the present application. Therefore, the patent protection of the present application shall be defined by the appended claims.

What is claimed is:

1. A new energy charging plug, comprising:
a plug body (1); and
a protective cover (2) configured for avoiding accidental electric shock;
wherein center of the plug body (1) is provided with a J1772 US-standard charging connector (4), a lower side of the J1772 US-standard charging connector (4) is provided with a lock slot (3); an upper side of the J1772 US-standard charging connector (4) is provided with a CCS1 US-standard charging connector (6); the protective cover (2) is rotatably connected with the plug body (1), corresponding to a position of the CCS1 US-standard charging connector (6) and closed with the CCS1 US-standard charging connector (6) under normal conditions.

2. The new energy charging plug according to claim 1, wherein, the protective cover (2) is connected with the plug body (1) by a spring pin shaft (7), the spring pin shaft (7) passes through the protective cover (2).

3. The new energy charging plug, wherein, the lock slot (3) of the plug body (1) is slidabley connected with a lock lever (5).
